(19) United States
(12) Patent Application Publication
(10) Pub. No.: US 2004/0015432 A1
(43) Pub. Date: Jan. 22, 2004

(54) Business method for creating and managing multilateral contractual relationships electronically and on a large scale

(76) Inventor: Harry D. Lewis, Long Island City, NY (US)

Correspondence Address: WILLIAM C. CRUTCHER, MCCORMICK, PAULDING & HUBER, LLP, 185 ASYLUM STREET, CITY PLACE II, 18TH FLOOR, HARTFORD, CT, 06103-4102, US

(21) Appl. No.: 10/620,241

(22) Filed: Jul. 15, 2003

Related U.S. Application Data
(60) Provisional application No. 60/397,218, filed on Jul. 19, 2002.

(51) Int. Cl. G06F 17/00; G06F 7/00; G06F 17/60

(52) U.S. Cl. 705/37; 707/104.1

(57) ABSTRACT

Method for creating and managing multilateral contractual relationships among “covered entities” and “business associates” under a privacy standard applicable to protected health information (PHI) by assigning digital identities to the contracting parties, providing a multilateral Master Business Associate Contract (MBAC) template having non-negotiable terms requiring observation of the privacy standard with respect to the PHI data, providing a self-certification standard affidavit template enabling the contracting parties to achieve self-certification, and providing an electronic interface over the internet to facilitate negotiating and entering binding multilateral contractual agreements among the parties pursuant to the terms of the affidavits and the MBAC template.

### CROSS REFERENCE TO RELATED APPLICATIONS

This application claims the benefits of prior filed, co-pending provisional patent application Serial No. 60/397,218 filed Jul. 19, 2002.

### BACKGROUND OF THE INVENTION

The invention is a business method for creating and managing thousands, hundreds of thousands, or even millions of the contractual relationships required to protect the privacy of personal health information under U.S. law electronically. The business method also can be used to create and manage multiple contractual relationships electronically in legal contexts other than those presented by health care.

The “Standards for Privacy of Individually Identifiable Health Information” (“Privacy Standards”) promulgated by the United States Department of Health and Human Services (“HHS”) under the Administrative Simplification Provisions of the Health Insurance Portability and Accountability Act of 1996 (“HIPAA”), and published at 45 C.F.R. Parts 160 and 164, require that “covered entities” (as defined in the regulations) contract with “business associates” (also defined in the regulations) to protect the privacy of personal health information about consumers.

The “business associate contract” requirement, set out specifically in 45 C.F.R. §164.504(e), requires “covered entities” (such as physicians, hospitals, and health plans) and “business associates” (such as law firms or accounting firms) to contract with each other to protect “protected health information” about consumers (“PHI”) that the covered entities disclose to the business associates in the ordinary course of business. Creating and managing these business associate contracts adds a huge burden to the heavy volume of paperwork that regulators already require of health care plans and providers.

The existing computer systems of “covered entities” and their “business associates” are not configured for the creation and management of such contracts. The total cost to small business alone of implementation of the Standards (both the “business associate contract” component and the other required components) has been estimated at $1.9 billion for the year 2003, and $9.3 billion for the years 2004-2012. The estimated cost to large business enterprises is much higher.

FIG. 1 represents the prior art as an entity/relationship model, where the rectangles represent one or more entities, and the trapezoids represent relationships between entities. One of many customers 10 discloses personal information to one of many covered entities 12, such as a physician, hospital or health plan. The customer's personal information is enhanced by the covered entity to become Protected Health Information (PHI), recorded and stored as one of many PHI records 14 by the covered entities 12. A bilateral business associate contract 16 is entered into between one of many covered entities 12 and one of many business associates 18, such as law firms or accounting firms. This contact 16 is required by law and gives permission 20 to disclose the PHI 14 to the business associate. A required privacy notice 22 is sent to the customer 10.

The health care industry has assumed that the multiple “business associate contracts” required by the regulations must be created and managed with thousands of bilateral paper contracts between thousands of covered entities and their business associates. Such a massive creation and exchange of bilateral paper contracts, coupled with the need to maintain, manage, and update the information contained therein, creates an expensive administrative burden that already has evoked widespread complaints from the industry.

The creation of bilateral contracts having standard terms and conditions, consistent definitions and relatively widely accepted undertakings, warranties and mutually binding agreements between the two parties to the contract has been facilitated in the prior art by so-called master contracts. The dissemination of master contracts suited to various special purposes has been greatly facilitated by publishing the master contracts on websites accessible over the internet. However, these bilateral master contracts do not lend themselves to interactive on-line negotiation of the less crucial terms while retaining non-negotiable terms. They usually simply provide for accessing the master contract on-line, filling in the names of the contracting parties and accepting the terms with a digital signature.

Examples of such prior art are located, as of the filing date of this application, at the websites identified by the following Uniform Resource Locators (URL's):

http://www.state.il.us/cms/persnl/Labor/master/tofc.htm

http://www.oft.org/oftsite/mc/

http://www.wwcta.org/table-ma.htm

http://www.readslikeabook.com/netbooks/info/MasterContract_{—}062702.pdf

http://www.purchase.umd.edu/general/morders/84306jlf.htm

http://www2.njstatelib.org/njlib/erate/ucontrct.htm

Changing the legal paradigm from creation and exchange of bilateral paper contracts to electronic creation and management of far fewer multilateral contracts using the mechanism of standardized, multilateral “master contracts” containing standard terms and conditions that enable electronic multilateral contracting among thousands or millions of parties to comply with the minimum legal requirements, while permitting bilateral or multilateral legal additions or modifications, reduces the costs of these transactions by an order of magnitude, and simplifies the problem of creating and managing contractual relationships significantly.

Web-based or Internet-based technology itself enables the creation and use of multilateral contracts as replacements for bilateral contracts in contexts (such as this one) where hundreds, thousands, or even millions of parties can contract with each other electronically using multilateral contractual regimes, contracting on a scale never before possible due to the practical limitations of paper-based contracting systems, whether bilateral or multilateral.

The technology also can be used to enable bilateral electronic contracts, either directly or as a function adjunct to the multilateral contracting system. In the case of the HIPAA business associate contract creation and management system, additions or modifications to the basic MBAC can be either bilateral or multilateral.

### SUMMARY OF THE INVENTION

Method for creating and managing multilateral contractual relationships among contracting parties under a privacy standard, said contracting parties comprising “covered entities” receiving data of customers and creating, recording, using, and disclosing private data of such customers in the ordinary course of business and “business associates” requiring the use of said private data, said method comprising the steps of:

(a) assigning digital identities to the contracting parties

(b) providing a multilateral Master Business Associate Contract (MBAC) template having non-negotiable terms requiring observation of said privacy standard with respect to said private data of a customer, and including provisions for contracting parties to certify adherence to said privacy standard as self-certified covered entities or as self-certified business associates,

(c) providing an electronic interface accessible to said digital identities to facilitate negotiating and entering binding multilateral contractual agreements among at least one self-certified covered entities and multiple self-certified business associates pursuant to the terms of said MBAC template, and

(d) storing said agreements in an MBAC database.

Preferably self-certification is accomplished either through a self-certification standard affidavit template for self-certification by electronic signature and storage in a separate self-certification database, or simply by inclusion of warranty clauses in the MBAC. Preferably, digital identification and linking are accomplished through conventional database techniques, in which each node (entity represented in the master database) is identified, located, and represented though attribute synchronization, XNS, XRI and XDI-type web identity service, or analogous technology. Preferably the electronic interface includes interactive means for negotiating additional terms with respect to use or disclosure of said private data.

### DRAWING

The invention will be better understood by reference to the following description, taken in connection with the accompanying drawing, in which:

FIG. 1 is an entity/relationship diagram of a prior art method of establishing multiple bilateral contracts regarding privacy of a customer's private data,

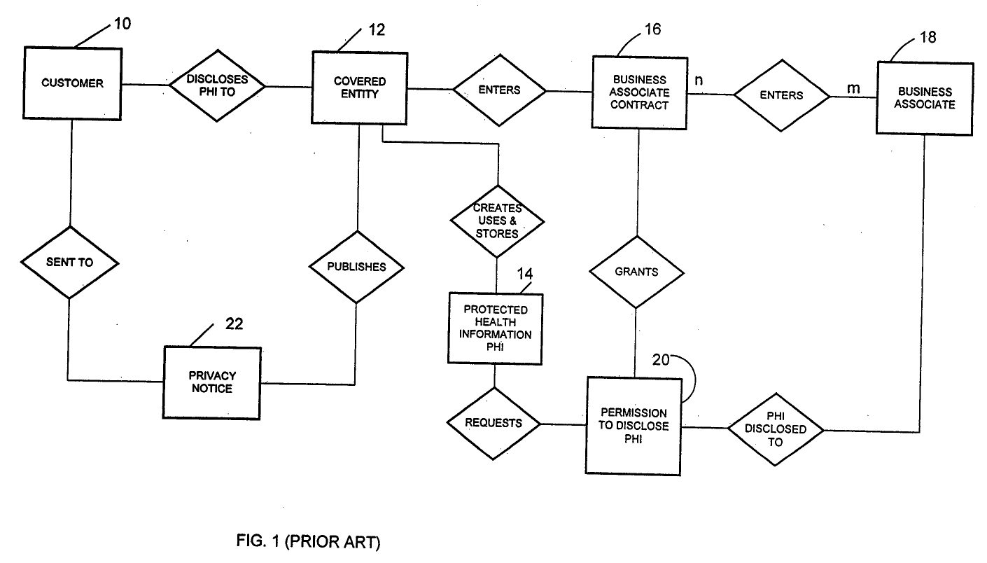

FIG. 2 is a similar entity/relationship diagram of the method of creating and managing a multilateral contractual relationship regarding privacy of a customer's private data in its simplest form according to the present invention, and

FIG. 3 is a similar entity/relationship diagram of the method of creating and managing a multilateral contractual relationship regarding privacy of a customer's private data, providing for self-certification through an affidavit, and providing for negotiation of negotiated terms in addition to the non-negotiable terms.

### DETAILED DESCRIPTION OF THE INVENTION

The Business Method

The business method uses conventional web hyperlinking and database technology to create a hybrid affiliate network in which each node (entity represented in the master databases) is identified, located, and represented through attribute synchronization, XNS, XRI and XDI-type web identity service, or analogous technology. http://www.xns.org: www.oasis-open.org/committees.xri. The electronic contract component of the system can be satisfied by any of the following three methods: (1) an exchange of messages via e-mail, paper, or fax; (2) the actions of electronic agents (software programmed to initiate or respond to electronic message offers); or (3) using website forms accepted by return message.

1. The first master database offers a standardized form affidavit (or similar legally binding document, such as an Unsworn Declaration under Penalty of Perjury under 28 U.S.C. §1746) that has the effect of permitting the person signing it to self-certify compliance with the Privacy Standards under oath or penalty of perjury.

2. Entities signing the affidavit are assigned a digital identity and locator enabling rapid identification and location both of the entity and of any information linked to that entity in the system. Links may be multilateral or bilateral within the system.

3. One or more standardized legal “offer(s)” to enter into one or more standardized, multilateral “Master Business Associate contract(s)” (“MBAC”) incorporating the requirements of the standardized business associate contract form published by HHS, but configured to permit additions, modifications, or alterations electronically that leave the legal requirements for business associate contracts set out in the Privacy Standards intact.

4. Each of these legal forms is presented to system users by a web page or similar interface linked to a database, and in an order that permits legal “offer(s)”, negotiations between or among some or all of the parties, and legal “acceptance” of the agreed upon terms.

5. Someone accessing the “self-certifying” web page can use an electronic signature or other legally binding mechanism (such as a paper affidavit faxed to the operator and imaged into a database) to “sign” the affidavit, which is stored in the database, and available to anyone searching it.

6. Anyone who has “self-certified” compliance with the Privacy Standards by signing the “self-certification” affidavit can then access the MBAC web page, which presents the standardized, multilateral Master Business Associate Contract(s) as part of a legal “offer” that can be legally “accepted”, once again, via electronic signature or other legally binding mechanism, such as a paper signature, to create an electronic or conventional contract.

7. The MBAC itself recites (among other things set out in more detail below) that the legal “consideration” for a covered entity's agreement to send PHI to a business associate is the business associate's agreement to become and remain compliant with the Privacy Standards (and any other applicable regulations), and to comply with the terms and conditions of the MBA.

8. The MBAC is designed to permit additions, modifications, or alterations by the parties, provided they do not impair the legally required components of the MBAC.

9. Once a party has legally “accepted” the legal “offer”, and has “signed” the multilateral MBAC (via electronic signature or other means), he or she is bound to its terms and conditions with respect to all other parties entering into the MBAC as an electronic or conventional contract. This enables a binding, multilateral electronic or conventional contractual relationship among multiple parties with a single signature per party, or with fewer signatures per party than a system of bilateral exchanges of paper contracts would require.

10. If the party has added terms and conditions to the multilateral MBAC, however, other contracting parties will not have contracted under the MBAC with respect to that party until they have specifically indicated their agreement to the additional terms and conditions via electronic signature or other legally binding mechanism.

11. The “self-certification” database will be linked to the MBAC database to ensure that all contracting parties have self-certified themselves HIPAA compliant under penalty of perjury.

12. The MBAC is designed to be multilateral, and enables creation and management of contracts among multiple parties without the detailed and expensive “fine-tuning” required in a one-to-one, bilateral conventional contract. If every party insists on customizing the MBAC, it will increase the burden of contracting as well as the complexity of the system, but the multilateral system still will operate far more quickly than a bilateral or multilateral paper contractual regime. In addition, retrieval, modification, and updates of existing contracts are greatly facilitated by the multilateral system.

Diagrammatic Illustration of the Invention

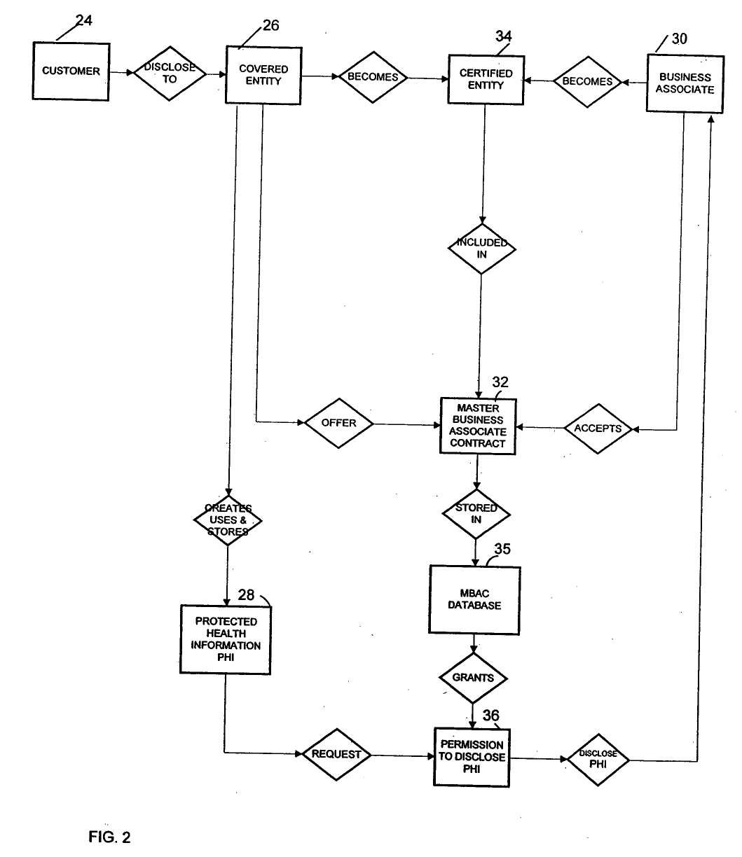

In its most general form, the invention is illustrated by the entity/relationship diagram of FIG. 2. As before, one of many customers 24 discloses personal information to one of many covered entities 26, such as a physician, hospital or health plan. The customer's personal information is enhanced by the covered entity to become Protected Health Information (PHI), recorded and stored as one of many PHI records 28 by the covered entities 26.

In accordance with the present invention, one of many covered entities 26 and one of many business associates indicated at 30 are assigned digital identities and enter into a multilateral Master Business Associate Contract (MBAC) 32, the terms of which are available uniformly to other covered entities and to other business associates. The MBAC 32 preferably includes both negotiable and nonnegotiable terms. From the standpoint of this application, the most important nonnegotiable terms are the Privacy Standards required for PHI records 28.

The invention also provides means for certification by the contracting parties of adherence to the Privacy Standards. This may simply be a warranty clause in the MBAC, and is shown in FIG. 2, wherein either a covered entity or a business associate becomes one of many certified entities 34 by signing the MBAC. FIG. 2 also assumes no negotiation of special terms, and a simple offer and acceptance of the MBAC. A completed contractual relationship among parties is stored as a record in an MBAC database 35. This record grants a permission 36 to disclose PHI to a certified contracting business associate 30.

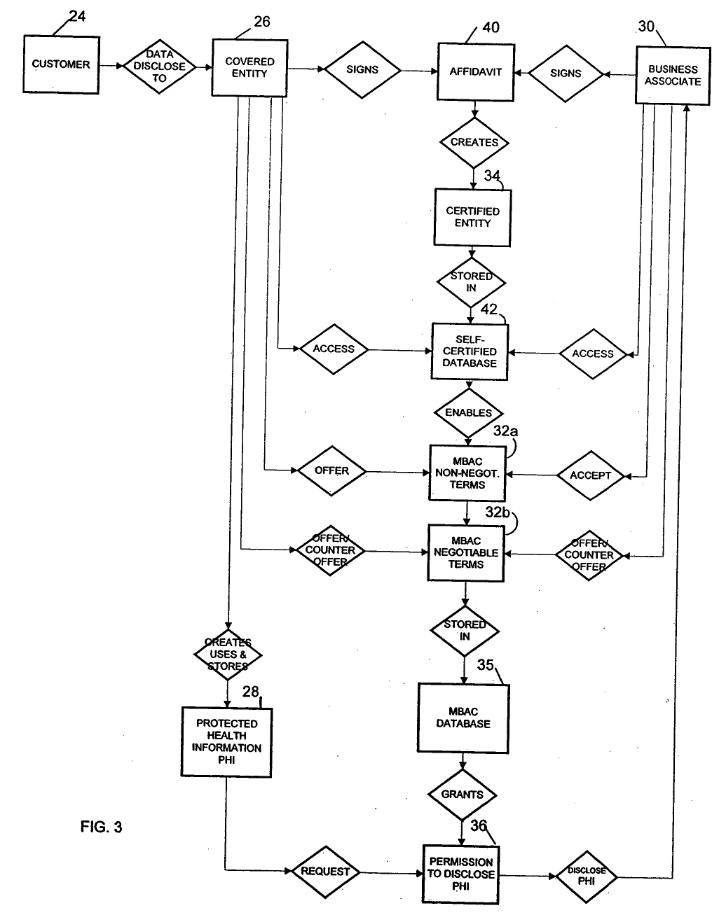

A preferred form of the invention is shown in FIG. 3, where the same reference numbers have been applied to entities having the same descriptions as in FIG. 2. However, the differences are noted as follows. Certification is carried out as a self-certification by a potential contracting party using a standardized form affidavit 40. A digital identity is assigned to an entity upon self-certification and the digital identity is stored in a separate self-certified database 42. The MBAC contains both negotiable terms 32a and non-negotiable terms 32b. Should the negotiation culminate in an agreement, the record of such agreement is stored in the MBAC database 35 as before.

The Relationship of the Self Certification Database to the MBAC Database

The Self Certification Database enables participants both to certify that they themselves comply with the Privacy Standards (and any other applicable regulations deemed relevant), and to ascertain that other persons to whom they propose to disclose PHI, or to whom they are disclosing PHI, also have certified such compliance, all under penalty of perjury. These self-certifications have the weight of law (and potential legal sanctions) to the extent the representations are made under penalty of perjury.

The self certifications can stand on their own to the extent that a covered entity such as a physician is not required to enter into a “business associate contract” to disclose PHI, but wants the comfort of knowing that the health care provider to whom he or she is disclosing PHI has certified his or her compliance with the Privacy Standards under penalty of perjury. Further, as a general proposition, covered entities are not required to police or inquire into the other party's compliance with the Privacy Standards except to obtain the assurances contained in the affidavit.

In cases where a business associate contract between or among parties is required to disclose PHI, the self-certification database operates as a “credentialing” mechanism by ensuring that all parties seeking to enter into a MBAC have themselves certified that they comply with the Privacy Standards and other applicable regulations under penalty of perjury.

The Self-Certification Database is separate from the MBAC, because the process of self-certification stands on its own, can be unilateral, part of a bilateral or multilateral contractual relationship, or even part of a separate regulatory regime, and may have its own self-contained utility beyond the narrower process of entering into a business associate contract. As already noted, a covered entity may want assurances that a party with whom it is not required to enter into a business associate contract is nonetheless in compliance with the Privacy Standards. This database provides such assurance.

The MBAC and the MBAC Database

Linked to the Self Certification Database (which already has operated to screen and credential parties seeking to enter into the MBAC as compliant with the HIPAA regulations under penalty of perjury, and therefore eligible to use, disclose, or receive “protected health information” (“PHI”) as defined in the HIPAA regulations), the MBAC sets out the standardized language required for a multilateral “business associate contract”, adds reciprocal and multilateral indemnification and reciprocal insurance requirements to the standardized HHS contract, inserts any “more stringent” state privacy requirements automatically (based upon the jurisdiction in which the consumer to whom the PHI relates resides), and uses arbitration as a default dispute resolution mechanism (subject to change or negotiation by the parties). It also incorporates the representations in the Self-Certification Affidavit by reference, making them representations material to the MBAC. The MBAC obligates the signatories both (1) to remain compliant with the HIPAA regulations during the time they are signatories; and (2) to use any PHI received from any other signatories in accordance with the requirements of the HIPAA regulations, as well as any addenda to the MBAC they have placed on file in the database.

The MBAC also incorporates the terms and conditions of the “Privacy Notice” that “covered entities” are required to provide to consumers under the HIPAA Privacy Standards by reference. The “addendum option” permits any signatory to add contractual addenda to the MBAC as set out in the supplemental database. Such supplements are cross-indexed and hyper linked in the database for easy access by any subscriber. No addenda may impair the standards required by the HIPAA regulations, including the legal rights granted to consumers by the Privacy Standards or applicable state law that provides more stringent privacy protection for consumers.

The default arbitration clause provides that disputes between any of the signatories will be subject to arbitration in the jurisdiction in which the protected health information at issue originated, and that the arbitrator shall have the authority to award legal or equitable relief equal to the most stringent remedies for violation of consumer privacy rights available to a plaintiff in a state court of competent jurisdiction, including, where applicable, attorney's fees and costs.

In addition to the “Self-Certification Database” and the “MBAC Database(s)” (which can be cross-indexed and linked), access to other databases or services can be included in the business model at additional charges, including a monthly e-mail newsletter, HIPAA compliance programs delivered online, links (referrals) to health care attorneys in different states (they can write state specific portions of the newsletters as the price of their inclusion, or just pay a fee for the referral where permitted by law), online arbitration services, and others.

In summary, web-based technology, combined with older Internet technologies (such as e-mail), fax, and traditional paper-based contracting technology enables use of the multilateral contract mechanism on a scale never before imaginable to enable the “business associate contract” mechanism of the HIPAA Privacy Standards.

1. Method for creating and managing multilateral contractual relationships among contracting parties under a privacy standard, said contracting parties comprising (1) “covered entities” receiving data of customers and creating, recording, using, and disclosing private data of such customers in the ordinary course of business, and (2) “business associates” requiring the use of said private data, said method comprising the steps of:
(a) assigning digital identities to the contracting parties;
(b) providing a multilateral Master Business Associate Contract (MBAC) template having non-negotiable terms requiring observation of said privacy standard with respect to said private data of a customer;
(c) providing an electronic interface accessible to said digital identities to facilitate negotiating and entering binding multilateral contractual agreements among at least one of said covered entities and a plurality of said business associates pursuant to the terms of said MBAC template; and
(d) storing said multilateral contractual agreements in an MBAC database.

2. The method according to claim 1, including the additional step of providing self-certification provisions in said MBAC for contracting parties to certify adherence to said privacy standard as self-certified covered entities or as self-certified business associates.

3. The method according to claim 1, wherein said electronic interface includes interactive means for negotiating additional terms with respect to use or disclosure of said private data.

4. Method for creating and managing multilateral contractual relationships among contracting parties under a privacy standard, said contracting parties comprising (1) “covered entities” receiving data of customers and creating, recording, using, and disclosing private data of such customers in the ordinary course of business, and (2) “business associates” requiring the use of said private data, said method comprising the steps of:
(a) assigning digital identities to the contracting parties;
(b) providing a multilateral Master Business Associate Contract (MBAC) template having non-negotiable terms requiring observation of said privacy standard with respect to said private data of a customer;
(c) providing self-certification procedures for contracting parties to certify adherence to said privacy standard as self-certified covered entities or as self-certified business associates;
(d) providing an electronic interface accessible to said digital identities to facilitate negotiating and entering binding multilateral contractual agreements among at least one of said self-certified covered entities and a plurality of said self-certified business associates pursuant to the terms of said MBAC template; and
(e) storing said multilateral contractual agreements in an MBAC database.

5. The method according to claim 4, wherein said self-certification procedures comprise the additional steps of:
providing a self-certification standard affidavit template for self-certification by electronic signature; and
storing affidavits corresponding to said template in a separate self-certification database.

6. The method according to claim 4, wherein said self-certification procedures comprise warranty clauses in said MBAC.

7. The method according to claim 4, wherein said electronic interface includes interactive means for negotiating said additional terms with respect to use or disclosure of said private data.

8. The method according to claim 4, wherein said interactive means includes means for a covered entity to offer and for a business associate to accept said non-negotiable terms in the MBAC.

9. The method according to claim 4 including the additional step of:
accessing a selected multilateral contractual agreement in said MBAC database for permission to disclose selected private data to a selected self-certified business associate.

10. The method according to claim 4, wherein said electronic interface comprises the internet.

11. Method for creating and managing multilateral contractual relationships among contracting parties under a privacy standard applicable to protected health information (PHI), said contracting parties comprising (1) “covered entities” receiving data of customers and creating, recording, using, and disclosing PHI data of such customers in the ordinary course of business, and (2) “business associates” requiring the use of said PHI data, said method comprising the steps of:
(a) assigning digital identities to the contracting parties;
(b) providing a multilateral Master Business Associate Contract (MBAC) template having non-negotiable terms requiring observation of said privacy standard with respect to said PHI data of a customer;
(c) providing a self-certification standard affidavit template for contracting parties to certify adherence to said privacy standard as self-certified covered entities or as self-certified business associates by electronic signature so as to achieve self-certification;
(d) storing affidavits corresponding to said template in a separate self-certification database;
(e) providing an electronic interface accessible to said digital identities, said electronic interface being selectively connectable to the self-certification database to facilitate negotiating and entering binding multilateral contractual agreements among at least one of said self-certified covered entities and a plurality of said self-certified business associates pursuant to the terms of said affidavits and said MBAC template; and
(f) storing said multilateral contractual agreements in an MBAC database.

12. The method according to claim 11, wherein said electronic interface includes interactive means for negotiating said additional terms with respect to use or disclosure of said PHI data.

13. The method according to claim 11, wherein said interactive means includes means for a covered entity to offer and for a business associate to accept said non-negotiable terms in the MBAC.

14. The method according to claim 11 including the additional step of:
accessing a selected multilateral contractual agreement in said MBAC database for permission to disclose selected PHI data to a selected self-certified business associate.

15. The method according to claim 11, wherein said electronic interface comprises the internet.
